(19) United States
(12) Patent Application Publication
(10) Pub. No.: US 2003/0008676 A1
(43) Pub. Date: Jan. 9, 2003

(54) Communication device having a microphone system with optimal acoustic transmission line design for improved frequency and directional response

(76) Inventors: John Charles Baumhauer JR., Indianapolis, IN (US); Larry Allen Marcus, Fishers, IN (US); Charles Varvaro, Glendale Heights, IL (US); James Edward West, Plainfield, NJ (US)

Correspondence Address: Gregory P. Gadson, Esq., 19375 Amber Way, Indianapolis, IN, 46060, US

(21) Appl. No.: 09/898,845

(22) Filed: Jul. 3, 2001

(51) Int. Cl. H04M 1/00

(52) U.S. Cl. 455/550; 455/575

(57) ABSTRACT

A noise-canceling microphone system suitable for use in small telephonic devices such as cellular “flip” telephones has one or more acoustic transmission lines embedded in the flip component through openings in the distal end of the flip component, and coupled to a microphone element carried by the main housing. The acoustic transmission lines have boots coupled to the microphone element to accommodate the swiveling action of the flip component. In a critical aspect of the present invention, the microphone assembly incorporated in a communication device has acoustic transmission tubes containing acoustic impedance elements matched to the specific acoustic characteristic resistance of the tubes to eliminate standing waves and thus resonances in the microphone frequency response. For all Zero-Order Gradient, First-Order Gradient and Second-Order Gradient microphone systems, the specific acoustic characteristic resistance of the acoustic transmission tubes are matched, and hence the phase and time delays of acoustic waves propagating therethrough are made to be proportional to the tube lengths by including impedance elements.

### FIELD OF THE INVENTION

The present invention broadly relates to microphone systems. More particularly, the present invention relates to so called “gradient” or subtractive type microphone systems suitable for use in small, portable communication devices.

### BACKGROUND OF RELATED ART

Customers often greatly value cellular telephones for their compact size. A popular cell telephone is the so-called “flip” telephone, which has a swivel-mounted flip component. In prior art flip telephones, the flip component is opened away from the body of the telephone to expose an embedded microphone element to the voice of the user and other sounds while the telephone is in use. When the flip telephone is not in use, the flip component can be folded against the body of the telephone for greater compactness.

Because the microphone element in prior art flip telephones is connected to other circuitry in the telephone body via wires, those wires are subject to repeated folding stress from opening and closing the flip component at the point where the flip component joins the telephone body.

It is also desirable to provide a noise-canceling microphone in flip telephones. However, when the wires of such a microphone are constantly bent and fatigued around the flip component and telephone body connection point, increased component failure may result.

Acoustic transmission tubes or “transmission lines” are useful to conduct sound entering a sound port at, for example, a position “P” relative to a distant microphone element at a position “Q.” The position P can be, for example, at the end of the “flip” element of a flip telephone, and the position Q can be in the body of said flip telephone. Alternatively, the positions P and Q can be contained in other sound transducing systems, such as speakerphones, recording microphones, personal communicators, and multimedia devices and systems.

A common problem associated with typical microphone elements is that they present high acoustical impedances, and therefore reflect acoustic energy back through the acoustic transmission line or lines coupled thereto, which can lead to reflections that produce standing waves in the acoustic transmission lines. Standing waves of this sort cause undesirable resonance peaks in the frequency response of a microphone system—especially for long lines, and there is virtually no phase delay (as would be associated with traveling waves) except near resonance frequencies. At the resonance peaks, there are uncontrolled phase changes which can negatively impact the desired polar or directional response of the microphone system.

It is desirable to deliberately and methodically reduce the resonance peaks in the frequency response of boom microphones using transmission tubes, in contrast to prior art approaches in which said resonance peaks are only accidentally eliminated or eliminated by clumsy trial and error methods in the alternative. Moreover, it is much more advantageous in the design of a microphone's directional response, that phase changes at all frequencies are proportional to transmission line lengths.

### SUMMARY OF THE INVENTION

In view of the above-identified problems and limitations of the prior art, the present invention provides a portable telephone at least including a main housing, a radio transmitter subsumed by the main housing, a radio receiver subsumed by the main housing, an alphanumeric keypad carried by the main housing, an audio reproduction transducer subsumed by, and located near a first end of the main housing, the transducer being adapted to produce aural signals for near-ear placement, and a flip component swively attached to the main housing near a second end, and a microphone element subsumed by the main housing. The telephone also at least includes:

a first acoustic transmission line embedded in the flip component and coupled to a first opening in the flip component, and coupled through a first outer input port in the main housing to the microphone element for transporting acoustic energy received at the first acoustic transmission line to a first position on the microphone element;

a second acoustic transmission line embedded in the flip component and coupled to a second opening in the flip component, and coupled through a second outer input port in the main housing to the microphone element for transporting acoustic energy received at the second acoustic transmission line to the first position on the microphone element;

a third acoustic transmission line embedded in the flip component and coupled to a third opening in the flip component, and coupled through a first inner input port in the main housing to the microphone element for transporting acoustic energy received at the third acoustic transmission line to a second position on the microphone element; and

a fourth acoustic transmission line embedded in the flip component and coupled to a fourth opening in the flip component, and coupled through a second inner input port in the main housing to the microphone element for transporting acoustic energy received at the fourth acoustic transmission line to the second position on the microphone element. Also included are a plurality of acoustic impedance elements, at least one being positioned in each of the acoustic transmission lines, and the at least one acoustic impedance element being substantially matched in specific acoustic resistance to the specific acoustic “characteristic” resistance of the respective acoustic transmission line.

The present invention also provides a microphone assembly incorporated in a communication device. The microphone assembly at least includes a microphone element adapted to convert acoustic energy into electrical energy, and an acoustic transmission line adapted to transmit acoustic energy received at the input port of the acoustic transmission line to an output port of the acoustic transmission line coupled to the microphone element. The specific acoustic resistance matches the specific acoustic characteristic resistance of the acoustic transmission line.

The present invention further provides a microphone assembly incorporated in a communication device. The microphone assembly at least includes a microphone element adapted to convert acoustic energy into electrical energy, a first acoustic transmission line adapted to transmit primary acoustic energy received at the input port of the first acoustic transmission line to an output port of the first acoustic transmission line coupled to a primary acoustic sound port of the microphone element, at least a second acoustic transmission line adapted to transmit secondary energy received at the input port of the second acoustic transmission line to an output port of the second acoustic transmission line coupled to a secondary acoustic sound port of the microphone element, and at least one acoustic impedance element, matched in specific acoustic resistance to the specific acoustic characteristic resistance of the line and positioned in each acoustic transmission line such that the time and phase delay in acoustic energy transmitted by the acoustic transmission lines is proportional to the lengths of the acoustic transmission lines. The acoustic energy received by the microphone element via the second acoustic transmission line is subtractive.

The present invention is described in detail below, with reference to the drawings.

### BRIEF DESCRIPTION OF THE DRAWINGS

Features and advantages of the present invention will become apparent to those skilled in the art from the following description with reference to the drawings, in which:

FIG. 1 shows the side and edge views of a cellular telephone constructed according to the microphone system of the present invention;

FIGS. 2A and 2B show end views of two Second-Order Gradient microphone system embodiments of the flip component of the telephone of the present invention;

FIG. 3 shows a First-Order Gradient microphone system for use in the present-inventive telephone;

FIG. 4 shows the acoustic transmission line/tube arrangement of a Second-Order Gradient microphone system for use in the present-inventive telephone;

FIG. 5 shows cross-section and bottom views of the aforementioned Second-Order Gradient microphone system;

FIG. 6 shows frequency response simulation data of a First-Order Gradient microphone system which was not built according to the present invention, for a “near field” distance of 1.3 inches (approximately 3.3 centimeters), and a “far field” distance of 1 meter (m);

FIG. 7 shows frequency response simulation data for the microphone system used for FIG. 6, except that each acoustic transmission tube is matched at its port to a resistance element having a resistance value that matches the tube's characteristic impedance;

FIG. 8 shows polar response simulation data for the microphone system used for FIG. 7 at 500 Hertz and 1 meter only, with the secondary tube length varied (2 inches and 2.7 inches); and

FIG. 9 shows frequency response simulation data for the microphone system used in FIG. 7, at 1.3 inches only, but with the port-to-matched impedance ratio varied (10, 5, 1, 1/2 and 1/10).

### DETAILED DESCRIPTION OF THE PREFERRED EMBODIMENTS

Used throughout this Letters Patent, “tubular” is used to describe elongated members whose cross-sections can have any shape—not just circular.

The present invention is applicable to Zero-Order Gradient (ZOG) microphone systems (omnidirectional microphones), as well as subtractive microphone systems such as First-Order Gradient (FOG) and Second-Order Gradient (SOG) microphone systems. It is also applicable to microphone systems using an array of additive microphone elements.

The present invention recognizes that time and phase delays caused by inherent sound wave propagation can be viewed not merely as a byproduct of the of the system, but may be used in the design process to obtain an advantageous microphone directional response, and thus an improved signal-to-noise ratio (SNR). That is, the relative (differential) lengths of the acoustic transmission tubes from P to Q or from P₁ to Q₁ and P₂ to Q₂, for example, in a FOG microphone system, can be made to be proportional to the relative time and phase delays. Thus, the present invention novelly constructs in communications devices, microphone systems in which the phase delay of an acoustic transmission tube is proportional to its length.

The reader's attention is directed to U.S. Pat. No. 5,848,172, having a common inventor with the present Letters Patent, and having the same assignee as the present Letters Patent, where it is stated:

In order that the acoustic phase delay along the respective acoustic transmission lines be in proportion to their length, L, as desired, the specific acoustic impedance of the acoustic impedance elements is chosen to match the specific acoustic characteristic impedance of the acoustic transmission lines, namely, ρ·c, where c and ρ are the wave speed of sound in, and the density of air, respectively. Thus, the acoustic impedance of the impedance elements is Rₐ=ρ·c/A, where A is the cross section area of the acoustic transmission lines.

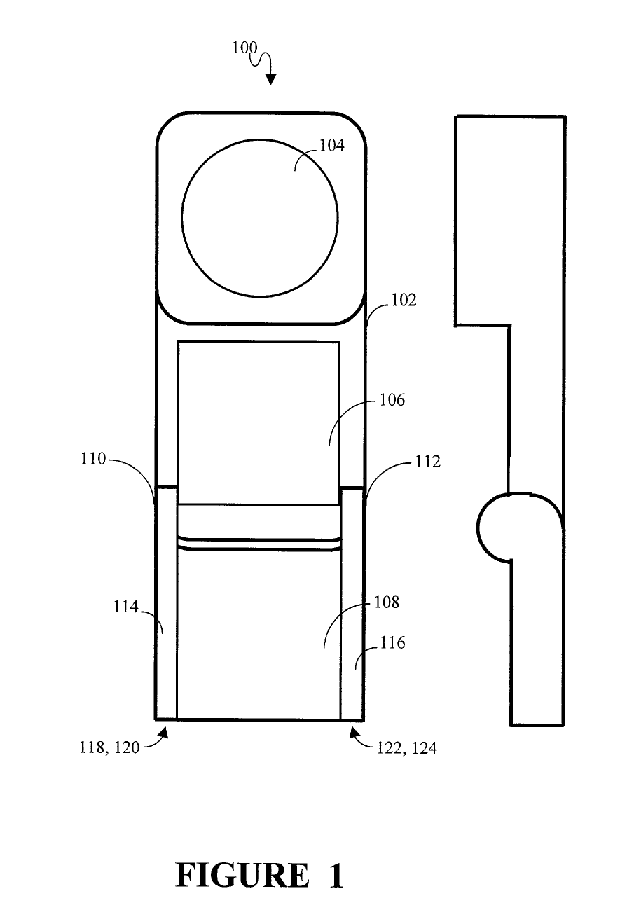

FIG. 1 shows the preferred embodiment of the present-inventive portable flip telephone 100 having a boom, echo-canceling microphone system that conducts acoustic energy via acoustic transmission lines embedded in the flip component to a microphone element residing in the body of the telephone.

The major components are: a main housing 102, an audio transducer 104 for converting audio signals received by the telephone 100 to aural signals; an alphanumeric keypad for entering alphanumeric digits as is known in the art; and a flip component which can be retracted when the telephone is not in use by swiveling the component around pivot hubs 110 and 112 for compact storage.

In contradistinction to the prior art, the flip component 108 contains tubular acoustic transmission lines embedded in regions 114 and 116. The acoustic transmission lines conduct acoustic energy received at the distal end of the flip component to a microphone element (not shown in FIG. 1) within the body 102 of the telephone 100.

In FIGS. 1, et seq., several acoustic transmission lines are shown. Given the novel teachings of the present invention, the number of acoustic transmission lines used is a matter of design choice for microphone directivity, and can range from one for a Zero-Order Gradient (ZOG) microphone system, to two for a First-Order Gradient (FOG) microphone system, or four or more for Second-Order and higher Gradient microphone systems, such as the microphone system disclosed in U.S. Pat. No. 5,848,172, which is also owned by the assignee of the present Letters Patent. Those skilled in the art are directed to the aforementioned letters patent for additional information about constructing monolithic directional microphones, as may be compatible with the present-inventive telephone.

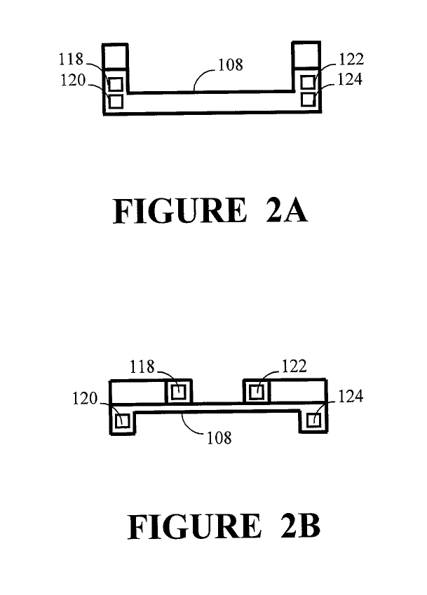

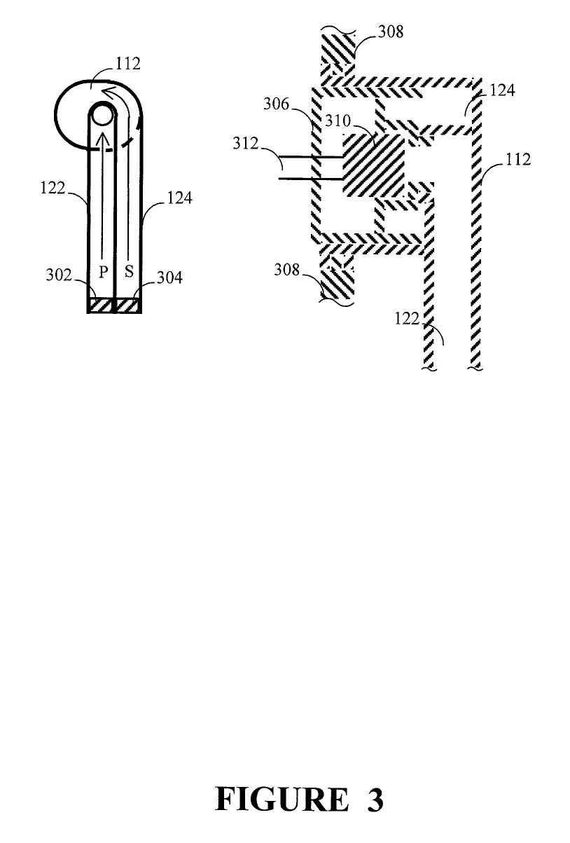

Returning to the illustration in FIG. 1, four acoustic transmission lines (118, 120, 122 and 124) are used in the preferred embodiment as part of a Second-Order Gradient (SOG) microphone system. The end views of a first and second embodiment of the flip element 108 are shown in FIGS. 2A and 2B, respectively. In the preferred embodiment, the acoustic transmission lines have matching acoustic impedances. Acoustic impedance matching means that appropriate acoustic impedance elements of such a value to match the tubes' specific acoustic characteristic resistance, such as the ones 302 and 304 (shown in FIG. 3), are placed in the transmission tubes. Acoustic impedance matching of the acoustic transmission tubes eliminates standing waves and hence leads to a higher quality of noise cancellation and fidelity.

The acoustic transmission lines and acoustic impedance elements of the present invention can be made of any suitable material as a matter of design choice, including, inter alia, plastic, foam, rubber and metal.

FIG. 3 shows close-up views of a side of the flip component 108, with emphasis on the acoustic transmission tubes and the microphone element coupled thereto. In the embodiment shown, a microphone element 310 is attached to a mounting 306 which is affixed to the inside of the telephone housing 102. The pivot hub 112 (or 110) of the flip component fits over the mounting 306, and is held in place by a flange 308 integrated into the wall of the telephone housing 102, which allows the flip component to rotate while maintaining a seal. The microphone element converts pressure waves representing sound into electrical signals output by the microphone output wires 312. Both directional and omni-directional microphone elements are compatible with the present invention. It should be noted that the embodiment shown in FIG. 3 is for a FOG, and that the primary pressure wave (denoted “P”) is received by the microphone element 310 via tube 122, while the secondary pressure wave (denoted “S”) is received by the microphone element 310 via tube 124. The microphone arrangement in FIG. 3 is converted to a ZOG by using only one acoustic transmission tube.

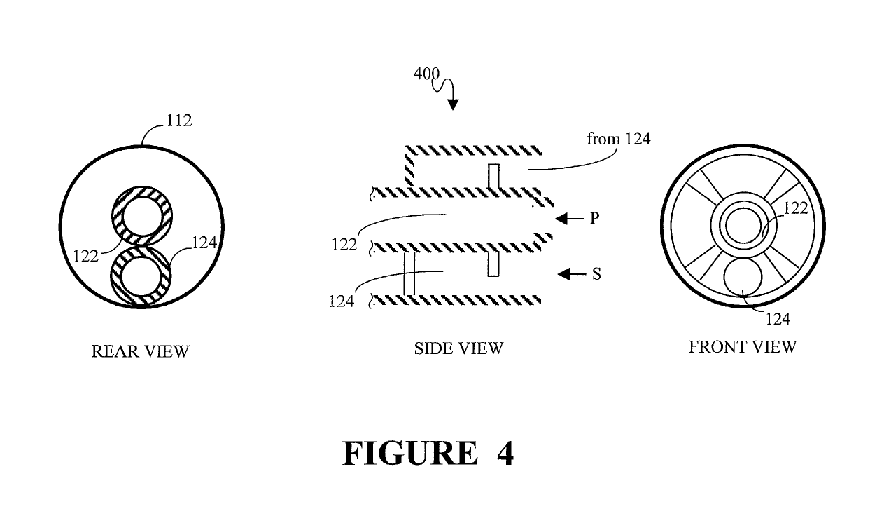

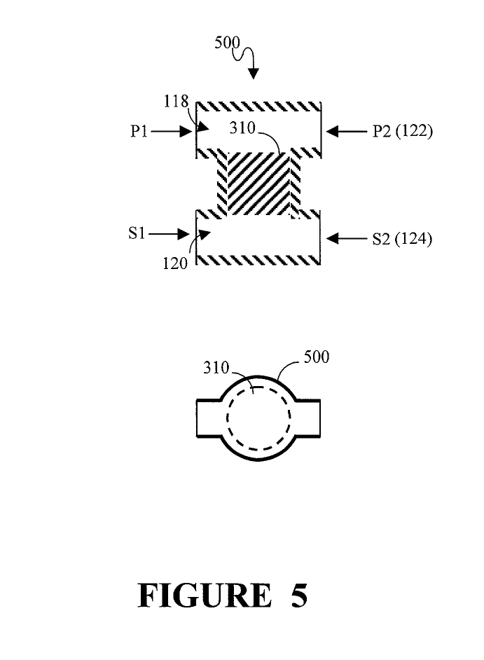

A Second-Order Gradient (SOG) microphone system is shown in FIGS. 4 and 5. The pivot hub 400 is as shown in FIG. 4, and the acoustic transmission tubes transmit primary (“P1” and “P2”) and secondary (“S1” and “S2”) pressure waves to the modified microphone element assembly 500 are shown in FIG. 5. It should be noted that the microphone element 210 in the SOG arrangement is coupled to both primary pressure acoustic transmission tubes 118 and 122, and both secondary pressure acoustic transmission tubes 120 and 124. When the microphone element is located nearer one side of the telephone than the other, as in the preferred embodiment, it will be appreciated that one pair of acoustic transmission tubes will be longer than the other pair. The phase change in the tubes can be made proportional to their length by adding appropriate acoustic impedance elements. The differences in the tube lengths then, along with the tubes' input sound port locations, allow custom design of the microphone directional response.

The pivot hub 400 replaces the pivot hub 306 and is shown in its rear, side and front views. In the illustration of FIG. 4, it is shown how the pressure from the right-side primary and secondary pressure acoustic transmission tubes 122 and 124, respectively, is transmitted through the hub 400. Although not shown, the hub 400 also similarly conducts pressure from the left-side primary and secondary pressure acoustic transmission tubes 118 and 120.

In the preferred embodiment, the assembly 500 is similar to the one in FIG. 3, in that it is secured to the main housing. However, the mounting for the gradient microphone element is a flexible material such as rubber to prevent damage to the acoustic transmission path due to movement of the flip component. The acoustic transmission tubes are joined to the microphone mounting with plastic sleeves for an interference fit.

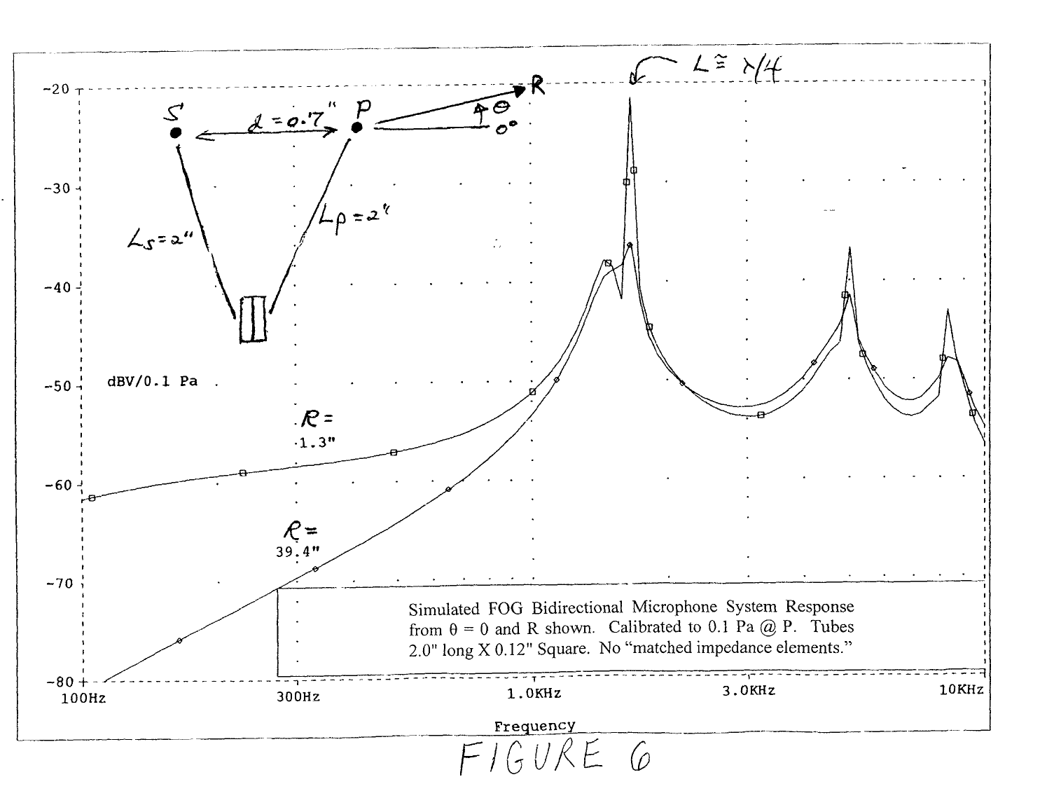

FIGS. 6 shows the frequency response of a FOG microphone system for “near-field” (1.3 inches) and “far-field” (39.4 inches or 1 meter) of a microphone system that has not been constructed according to the present invention. From that figure, it is seen that a resonance peak occurs at approximately 1600 Hertz, which is well within the audible range, and which contributes to poor polar and frequency responses. This particular microphone system has no “matched” acoustic impedance elements in the acoustic transmission tubes.

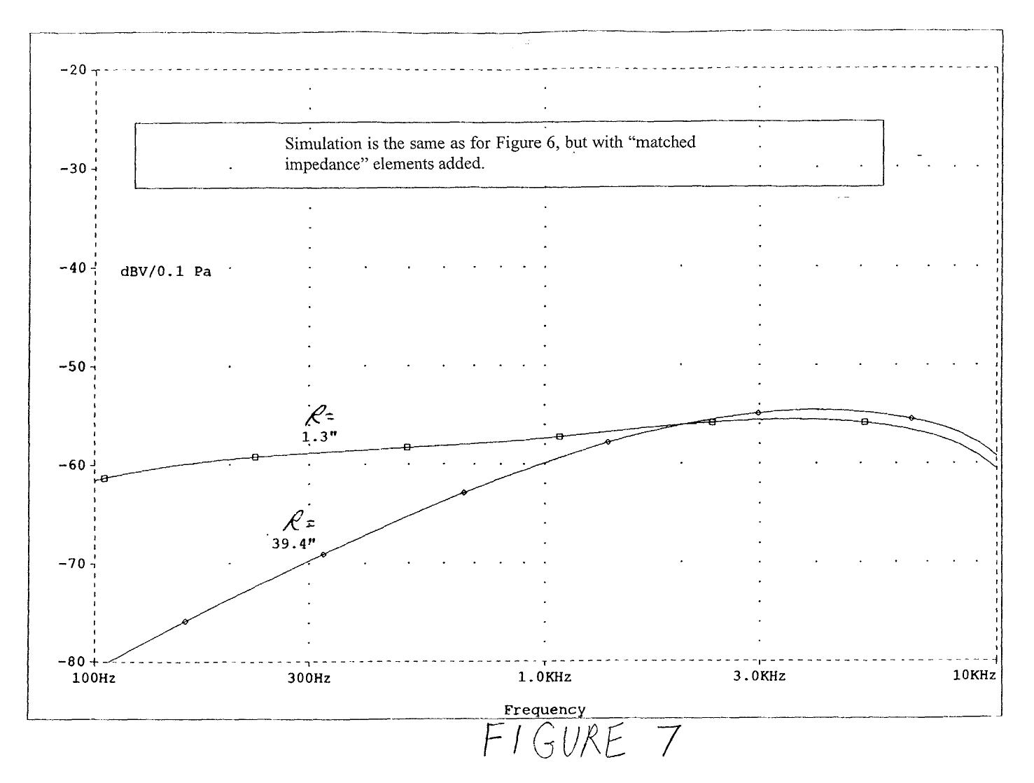

Unlike FIG. 6, FIG. 7 shows frequency response simulation data where both acoustic transmission tubes are now impedance matched by including matched impedance elements according to the teachings of the present invention. From the figure, it can be seen that smooth frequency response is produced, as is expected. Moreover, the microphone's polar response is greatly improved in the vicinity of 1600 Hertz.

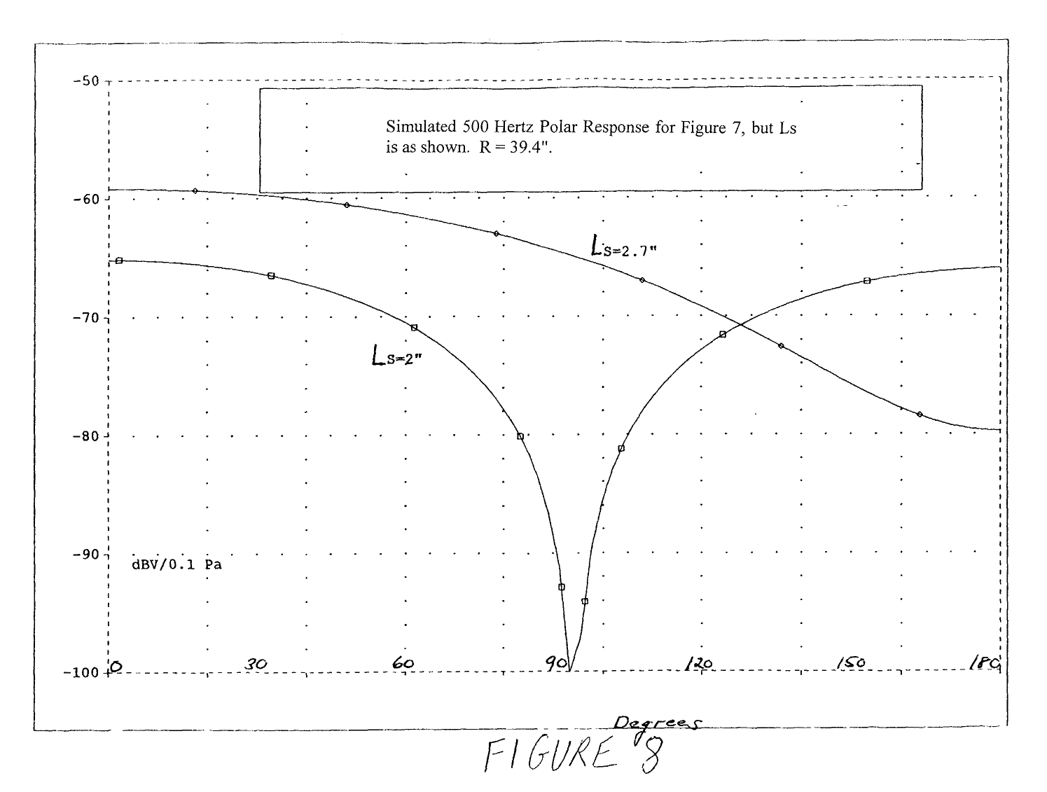

The polar response in FIG. 8 is for the microphone system of FIG. 7 at 500 Hertz and 1 meter, and from 0 to 180 degrees, where the length of a secondary tube in the FOG of FIG. 7 is varied (2 inches and 2.7 inches). From FIG. 8, it can be seen that for a secondary length of 2 inches, a null is produced at approximately 90 degrees. Also, for a secondary length of 2.7 inches instead, the null shifts to 180 degrees, and a “cardioid response is produced.

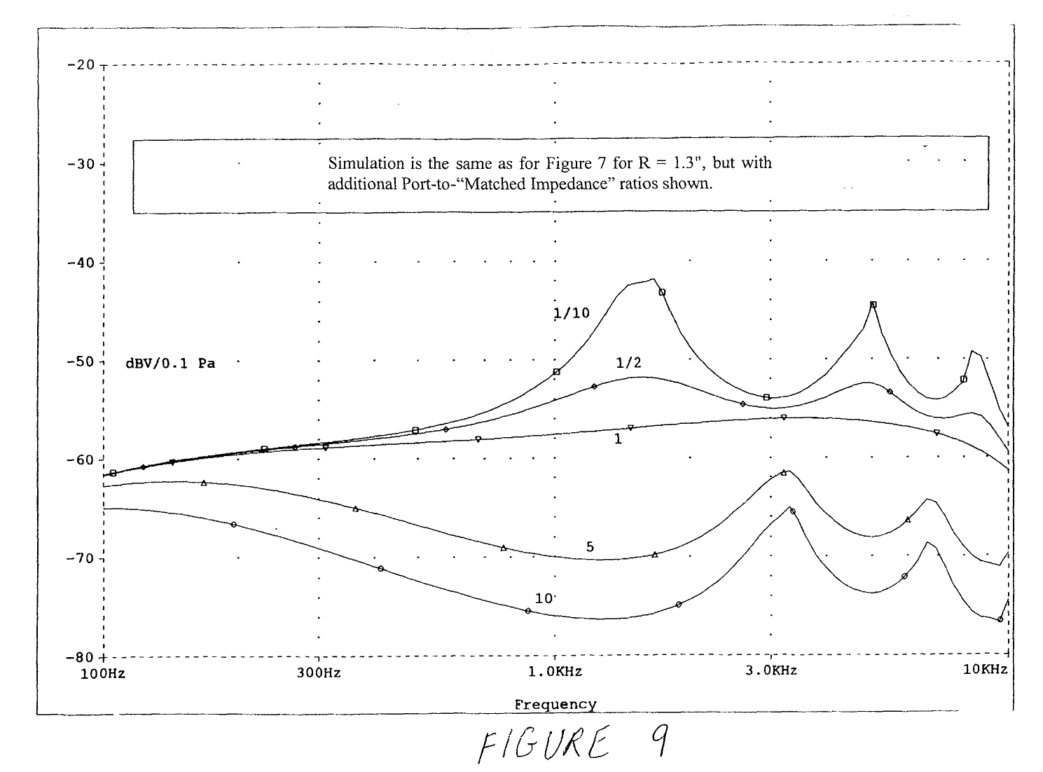

In FIG. 9, simulation frequency response data is shown for the microphone system of FIG. 7 in the near field (1.3 inches) having equal acoustic tube lengths, but varying degrees of acoustic impedance matching. It can be seen from the figure that a flat frequency response curve (identified as “1”) is produced for the case where the acoustic impedance at the ports equals the optimal “matched” impedance achieved by the present invention.

Thus, has been described a novel, portable flip telephone with an echo canceling Second-Order Gradient microphone system wherein acoustic transmission lines embedded in the flip component transmit acoustic energy to a microphone element attached to the main housing, to produce the desired polar response (e.g., cardioid, or bi-directional) sought in a particular microphone system design to maximize noise canceling.

Thus, also has been described in general, the novel inclusion in a communication device, a microphone system in which the relative time and phase delays of the acoustic transmission tubes is made to be proportional to their lengths, to improve directivity and the signal-to-noise ratio.

Variations and modifications of the present invention are possible, given the above description. However, all variations and modifications which are obvious to those skilled in the art to which the present invention pertains are considered to be within the scope of the protection granted by this Letters Patent.

While the invention has been described with reference to the exemplary embodiments thereof, those skilled in the art will be able to make various modifications to the described embodiments of the invention without departing from the true spirit and scope of the invention.

For, example, those skilled in the art will appreciate that the ports connected to the transmission lines in the present-inventive microphone assemblies do not have to lie in the same plane.

What is claimed is:

1. A wireless, portable telephone comprising:
main housing;
a radio transmitter subsumed by said main housing;
a radio receiver subsumed by said main housing;
an alphanumeric keypad carried by said main housing;
an audio reproduction transducer subsumed by, and located near a first end of said main housing, said transducer being adapted to produce aural signals for near-ear placement;
a flip component swively attached to said main housing near a second end;
at least one microphone element subsumed by said main housing;
a first acoustic transmission line embedded in said flip component and coupled to a first opening in said flip component, and coupled through a first outer input port in said main housing to said microphone element for transporting acoustic energy received at said first acoustic transmission line to a first position on said microphone element;
a second acoustic transmission line embedded in said flip component and coupled to a second opening in said flip component, and coupled through a second outer input port in said main housing to said microphone element for transporting acoustic energy received at said second acoustic transmission line to said first position on said microphone element;
a third acoustic transmission line embedded in said flip component and coupled to a third opening in said flip component, and coupled through a first inner input port in said main housing to said microphone element for transporting acoustic energy received at said third acoustic transmission line to a second position on said microphone element;
a fourth acoustic transmission line embedded in said flip component and coupled to a fourth opening in said flip component, and coupled through a second inner input port in said main housing to said microphone element for transporting acoustic energy received at said fourth acoustic transmission line to said second position on said microphone element; and
a plurality of acoustic impedance elements, at least one being positioned in each of said acoustic transmission lines, and the at least one acoustic impedance element being substantially matched in specific acoustic resistance to the specific acoustic characteristic resistance of the respective acoustic transmission line.

2. The telephone in claim 1, wherein said acoustic transmission lines have substantially matched acoustic impedances.

3. The telephone in claim 1, wherein said acoustic transmission lines have relative lengths to produce a cardioid polar response in said microphone element.

4. The telephone in claim 1, wherein said acoustic transmission lines comprise flexible tubular hinges coupled between said flip component and said microphone element.

5. The telephone in claim 1, wherein said ports need not lie in the same plane.

6. A microphone assembly incorporated in a communication device, said microphone assembly comprising:
a microphone element adapted to convert acoustic energy into electrical energy;
an acoustic transmission line adapted to transmit acoustic energy received at the input port of said acoustic transmission line to an output port of said acoustic transmission line coupled to said microphone element; and
at least one acoustic impedance element placed within said acoustic transmission line having a specific acoustic resistance that matches the specific acoustic characteristic resistance of said acoustic transmission line;
wherein the relative time and phase delays of acoustic energy propagating through said acoustic transmission line is proportional to the length of said acoustic transmission line due to the elimination of standing waves.

7. The microphone assembly in claim 6, wherein the specific acoustic characteristic resistance is defined by the product of the density of the sound medium and the wave speed of sound in the medium, divided by the cross-sectional area of the acoustic transmission line.

8. A microphone assembly incorporated in a communication device, said microphone assembly comprising:
a microphone element adapted to convert acoustic energy into electrical energy;
a first acoustic transmission line adapted to transmit primary acoustic energy received at the input port of said first acoustic transmission line to an output port of said first acoustic transmission line coupled to a primary acoustic sound port of said microphone element; and
at least a second acoustic transmission line adapted to transmit secondary energy received at the input port of said second acoustic transmission line to an output port of said second acoustic transmission line coupled to a secondary acoustic sound port of said microphone element;
wherein the specific acoustic characteristic resistance of said acoustic transmission lines are substantially matched by the specific acoustic resistance of at least one acoustic impedance element positioned in each said acoustic transmission line, whereas standing waves are eliminated in the acoustic transmission lines allowing the relative time and phase delays of acoustic energy propagating through said acoustic transmission lines be proportional to the length of said acoustic transmission lines; and
wherein the acoustic energy received by said microphone element via said second acoustic transmission line is subtractive.

9. The microphone assembly in claim 8, further comprising:
at least a third acoustic transmission line adapted to transmit primary acoustic energy received at the input port of said third acoustic transmission line to an output port of said third acoustic transmission line coupled to a primary acoustic sound port of said microphone element; and
at least a fourth acoustic transmission line adapted to transmit secondary acoustic energy received at the input port of said fourth acoustic transmission line to an output port of said fourth acoustic transmission line coupled to a secondary acoustic sound port of said microphone element;
wherein the acoustic energy received by said microphone element via said fourth acoustic transmission line is also subtractive.

10. A method of converting acoustic energy into electrical energy comprising the steps of:
via an acoustic transmission line, transmitting acoustic energy received at the input port of said acoustic transmission line to an output port of said acoustic transmission line coupled to a microphone element;
via said microphone element, converting acoustic energy received from said acoustic transmission line into electrical energy; and
positioning at least one acoustic impedance element within said acoustic transmission line having a specific acoustic resistance that matches the specific acoustic characteristic resistance of said acoustic transmission line;
wherein the relative time and phase delays of acoustic energy propagating through said acoustic transmission line is proportional to the length of said acoustic transmission line to eliminate standing waves.

11. The method in claim 10, wherein the characteristic impedance is defined by the product of the density of the sound medium and the wave speed of sound in the medium, divided by the cross-sectional area of the acoustic transmission line.

12. In a communication device, a method of converting acoustic energy into electrical energy comprising the steps of:
via a first acoustic transmission line, transmitting primary acoustic energy received at the input port of said first acoustic transmission line to an output port of said first acoustic transmission line coupled to a primary acoustic sound port of a microphone element;
via at least a second acoustic transmission line, transmitting secondary energy received at the input port of said second acoustic transmission line to an output port of said second acoustic transmission line coupled to a secondary acoustic sound port of said microphone element;
via said microphone element, converting acoustic energy into electrical energy; and
positioning at least one acoustic impedance element in each said acoustic transmission line, wherein the specific acoustic characteristic resistance of said acoustic transmission lines are substantially matched by the specific acoustic resistance of said acoustic impedance element, whereas standing waves are eliminated in the acoustic transmission lines allowing the relative time and phase delays of acoustic energy propagating through said acoustic transmission lines be proportional to the length of said acoustic transmission lines;
wherein the acoustic energy received by said microphone element via said second acoustic transmission line is subtractive.

13. The method in claim 12, further comprising the steps of:
providing at least a third acoustic transmission for transmitting primary acoustic energy received at the input port of said third acoustic transmission line to an output port of said third acoustic transmission line coupled to a primary acoustic sound port of said microphone element; and
providing at least a fourth acoustic transmission line for transmitting secondary acoustic energy received at the input port of said fourth acoustic transmission line to an output port of said fourth acoustic transmission line coupled to a secondary acoustic sound port of said microphone element;
wherein the acoustic energy received by said microphone element via said fourth acoustic transmission line is also subtractive.
